(19) United States
(12) Patent Application Publication
(10) Pub. No.: US 2002/0086585 A1
(43) Pub. Date: Jul. 4, 2002

(54) Insulation device of an electric element

(76) Inventors: Benoit Butaye, Caen (FR); Patrice Gamand, Douvres la Delivrande (FR)

Correspondence Address: Michael E. Marion, c/o U.S. PHILIPS CORPORATION, Intellectual Property Department, 580 White Plains Road, Tarrytown, NY, 10591, US

(21) Appl. No.: 10/011,882

(22) Filed: Dec. 4, 2001

(30) Foreign Application Priority Data
Dec. 5, 2000 (FR) 0015750

(51) Int. Cl. H01R 13/40

(52) U.S. Cl. 439/625

(57) ABSTRACT

The invention relates to an insulation device (10) intended to prevent the propagation of electromagnetic radiation produced by at least one electric element integrated with a low-resistivity (11) substrate, said insulation device (10) being robust and having uniform isolation properties in space.

An insulation device (10) according to the invention includes a plurality of isolation trenches (12) which stretch out in the substrate and are substantially parallel to each other, and a plurality of series of isolation transverses (13) having a depth which is close to that of said isolation trenches, said trenches (12) and said series of transverses (13) containing a resistive material having a higher resistivity than the resistivity of the substrate, each series of transverses being realized transversely between two adjacent isolation trenches and arranged so that two transverses included between two adjacent series are not each other's extension.

The invention relates to an insulation device intended to avoid the propagation of electromagnetic radiation produced by at least one electric element integrated with a low-resistivity substrate, said insulation device including a plurality of isolation trenches which stretch out in the substrate and are substantially parallel to each other, said trenches containing a resistive material which has a higher resistivity than the resistivity of the substrate.

The invention also relates to an integrated circuit including such insulation device. More particularly, the insulation device may advantageously be used in an integrated circuit which includes passive elements which are subjected to high-frequency currents such as, for example, an inductive element, a capacitor, a connection pad, an input/output pad, the properties of such passive elements being dependent on their electrical insulation.

The document EP 0 966 040 A1 shows an integrated circuit including such insulation device. The insulation device described in this document includes in a first embodiment a series of mutually parallel isolation trenches having spacings in one direction, filled with a resistive material whose resistivity is higher than that of the substrate. This embodiment corresponds to the insulation device as defined in the opening paragraph.

Such insulation device permits to locally increase the resistance of the substrate and to diminish the influence of capacitive phenomena between the integrated electric element and the substrate. These two effects lead to an electrical insulation of the electric element, which permits to obtain an operation of said element that is of a better quality than when said element is directly integrated with the substrate that has low resistivity.

This first embodiment has the drawback of permitting only limited insulation, because the resistance of the substrate is solely increased on a surface bounded by parallel trenches. In a more effective embodiment also outlined in document EP 0 966 040 A1, isolation trenches stretch out in the substrate in the form of a cross formed by spaced-apart isolation trenches running parallel with each other in a first direction and spaced-apart isolation trenches running parallel with each other in another direction, perpendicular to the first direction. The resistance of the substrate is thus increased over nearly the whole surface, only raised substrate members present between the trenches showing a low resistivity.

The invention is linked with the following considerations: The known insulation device is realized in a cross-pattern, so that the trenches in the two perpendicular directions mark off the boundaries of the raised members of the substrate which are substantially aligned to the two directions of the trenches. Each intersection between trenches in two perpendicular directions thus marks off the boundary of four raised members of the substrate. In the current state of the art, the conditions of etching such a pattern are such that the form of the corners of the raised members of the substrate is not reproducible from one intersection to the next. Thus, the raised members are all different and are not perfect parallelepipeds. In consequence, when the trenches are filled with material that has a higher resistivity than that of the substrate, the raised members meet with dissymmetric constraints, which may make them lean during the filling of said trenches and thereafter. For example, when the circuit is in operation, thermal constraints combined with the dissymmetry of the raised members often causes a deformation to occur of the raised members of the substrate. These physical problems affect the properties of the insulation given by the insulation device. Thus, said device has non-uniform properties in space and time.

It is an object of the invention to provide an insulation device which is robust and has uniform insulation properties in space.

In effect, an insulation device in accordance with the opening paragraph is characterized according to the invention in that it includes a plurality of series of isolation transverses which have a depth that is close to that of said isolation trenches, and which contain a resistive material that has a higher resistivity than the resistivity of the substrate, each series being realized transversely between two adjacent isolation trenches and arranged so that two transverses between two adjacent series are not each other's extension.

In the insulation device the raised members of the substrate are substantially aligned in one direction and shifted in “staggered rows” in a second direction. Each intersection between a trench and a transverse marks off the boundary of three raised members of the substrate. This geometry, which produces a similar pattern to that of a stacking up of bricks in a wall, permits a better holding of the substrate raised members and, in consequence, a good uniformity in space as well as a proper robustness in time of the insulation device. The invention may be used to advantage in the scope of the insulation of electric elements which have an operation whose quality depends on losses caused by a perpendicular direction to the plane of the element. Said losses occur due to parasitic capacitances and resistances in the layers underlying and/or overlying to the element. Such parasitic magnitudes are modified in the sense of diminishing losses via the characteristics of the modified substrate. The principle of these modifications is similar to this obtained in the prior art.

However, with certain elements as passive elements, radial currents parallel to the plane of the element may be developed during the operation of said element. These currents give rise to energy losses by the Joule effect provided that the environment is resistive. It is an object of the invention to reduce these energy losses by short-circuiting said radial currents.

In fact, an insulation device according to an advantageous embodiment of the invention is characterized in that it includes a conductive layer disposed between the electric element and the substrate, and means for isolating said conductive layer from said element.

In this insulation device the radial currents appearing during the operation of the electric element concentrate in the conductive layer where they are located. Energy losses are minimized because these currents flow in a low-resistive medium and these currents can be discharged, for example, by connecting the conductive layer to ground of the circuit.

In the case of an inductive electric element, generally formed by a metallic spiral, an additional phenomenon occurs: a circumferential current is induced into the layer subjacent and superjacent to the metallic spiral. This is noticeable when the substrate is low-resistive. The quality of the operation of the inductive element is generally determined by the value of a quality factor calculated on the basis of characteristics belonging to the inductive element and to its environment. The presence of the circumferential current influences the quality factor of the inductive element in two ways: via resistive losses caused by these currents flowing in resistive media; via mutual couplings according to which a circumferential current induced in a layer in its turn induces a magnetic field which has a way opposed to the way of the one that has induced the magnetic field, that is to say, that of the metallic spiral. The induced magnetic field brings about a reduction of the inductance of the inductive element.

The increase of the resistance of the substrate permits to limit the amplitude of these induced currents but increases the resistive losses, whereas the presence of a conductive layer diminishes the resistive losses but augments the value of the induced magnetic field.

A particularly advantageous embodiment of the invention permits to limit the amplitude of these induced circumferential currents without augmenting the resistive losses by proposing an insulation device which includes a conductive layer that forms an open circuit.

Such an open circuit limits the development of circumferential currents which are loop currents. The conductive layer may particularly be formed by conductive segments which minimize the circumferential currents induced by the magnetic field of the inductive element in the conductive layer by preventing their extension over considerable surfaces while short-circuiting the currents that would flow in a more resistive subjacent or superjacent medium when this conductive layer does not exist. The conductive segments may be connected to a non-closed frame. The assembly thus functions as an open circuit as regards the currents that could be induced there.

In a more general manner, the present invention may be utilized in any circuit that includes an electric or electronic element that is advantageously isolated from the substrate. The integrated circuit may be, for example, an oscillator, an active load mixer or a filter. In one of its applications the invention thus also relates to an oscillator intended to deliver an output signal which has a frequency whose value depends on the value of a tuning voltage, characterized in that it is realized in the form of an integrated circuit as described above, further including at least one varicap diode connected to the inductive element and intended to be biased by means of the tuning voltage.

More generally, the present invention may be advantageously used in a radio signal receiving apparatus.

These and other aspects of the invention are apparent from and will be elucidated, by way of non-limitative example, with reference to the embodiment(s) described hereinafter.

In the drawings:

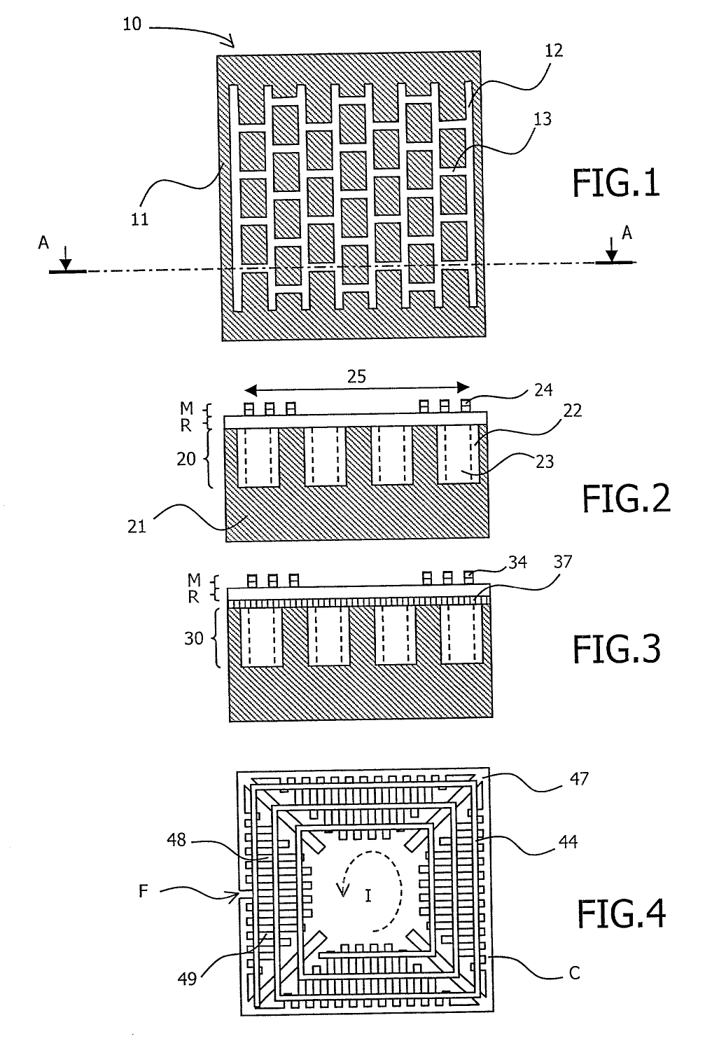

FIG. 1 is a plan view of an insulation device in accordance with the invention without the integrated electric or electronic element,

FIG. 2 is a section representing an integrated circuit in accordance with an advantageous embodiment of the invention,

FIG. 3 is a plan view of a conductive layer used in an insulation device of an inductive element,

FIG. 4 is a plan view of two inductive elements present in a circuit according to a variant of the invention,

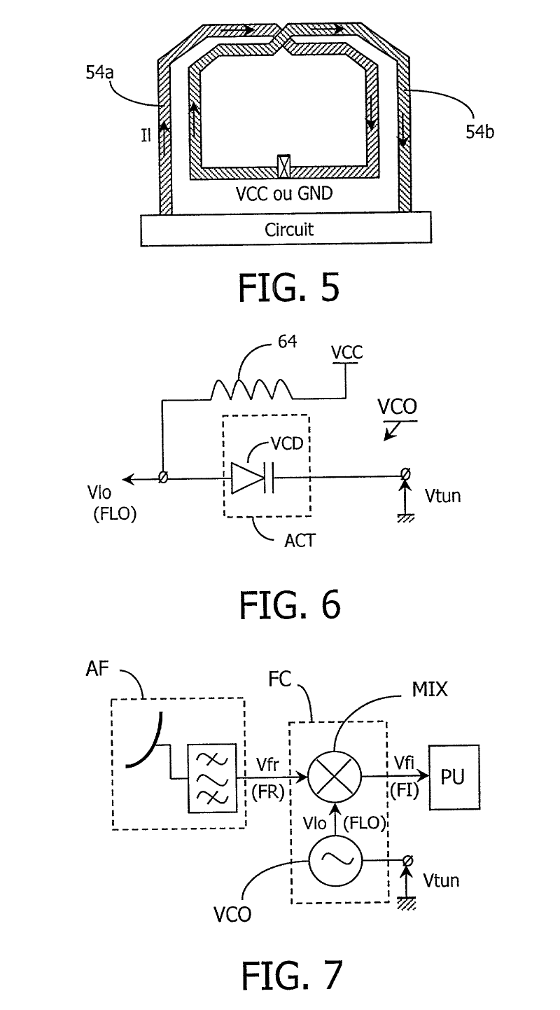

FIG. 5 is a flow chart of an oscillator in accordance with a particular embodiment of the invention, and

FIG. 6 is a flow chart of a radio signal receiving apparatus comprising such oscillator.

FIG. 1 is a plan view of an insulation device 10 according to the invention integral with a substrate 11. Said insulation device includes a plurality of isolation trenches 12 substantially running in parallel with each other and a plurality of series of isolation transverses 13, each series being realized transversely between two adjacent isolation trenches and arranged so that two transverses included in two adjacent series are not each other's extension. This particular geometry permits the raised members of the substrate to be properly held in position and, consequently, a substantial uniformity in space of the properties of the insulation device as well as proper robustness with time. The trenches and the series of transverses are filled with a material which has higher resistivity than that of the substrate 11, or possibly of a combination of various materials. The assembly constituted by the trenches and the series of transverses forms a resistive isolation grid. This isolation grid replaces the substrate volume at the trenches and transverses, the overlap factor of this grid varies according to the properties required for the insulation device. The manufacturing of an insulation device according to the invention implements methods which permit to fold the substrate or implant ions in certain regions of this substrate, these methods conventionally utilizing masks with the object of obtaining the geometry of the insulation device claimed.

FIG. 2 is a section along a section plane AA represented in the preceding Figure of an integrated circuit which includes an insulation device 20 according to the invention. The insulation device 20 is, by way of example, intended here to isolate an inductive element 24 superposed on the substrate 21. This inductive element 24 is, for example, formed by a metallic spiral realized in a metallic layer M and marking off by its outward shape the boundary of a surface called isolation surface 25 represented here in one dimension. Advantageously, the insulation device has a substantially identical surface to the isolation surface. The isolation trenches 22 are represented in FIG. 2 by dotted lines, because they do no occur in the section plane. The transverses 23 present in the section plane belong to every second series and are in this example each other's extension as represented in FIG. 1. The trenches and the series of transverses have substantially identical depths and are filled with a material that has a higher resistivity than that of the substrate. The depth of the trenches, their width and the ratio between these two magnitudes are unimportant for the problem resolved by the invention. The choice of these magnitudes depends on the properties which are required for the insulation device. A layer R formed by insulating material is present between the insulation device 20 and the electric element 24 realized in layer M.

The invention may be used within the scope of the insulation of electric elements which have an operation whose quality depends on losses which follow a direction perpendicular to the plane of the element. Said losses are generated by capacitances and parasitic resistances in the layers subjacent and superjacent to the element. In the absence of an insulation device, the overall parasitic capacitance between the substrate and the electric element is considerable. In the presence of the isolation grid the overall parasitic capacitance is diminished because the local capacitances between the grid and the insulation layer are small; other parasitic capacitances are in this case formed by the self-capacitance of the grid, which is small, and by the parasitic capacitance between the substrate and the resistance material filling the trenches and transverses. The resulting overall capacitance is then notably smaller than when there is no grid. This contributes to an improvement of the quality of the operation of the electric element.

Another parasitic phenomenon relates to the radial currents flowing in a plane parallel to the plane of the element and thus in the substrate when there is no insulation device. These currents generate losses via the Joule effect. When there is an isolation grid, these currents always flow in the substrate underneath said grid. However, these currents have limited intensity because of the presence of the high resistance of the resistive material that fills the trenches and transverses, which resistance is to be passed through by said currents before they flow in the substrate.

FIG. 3 shows an advantageous embodiment of the invention in which these radial parasitic currents are short-circuited thanks to a combination of the resistive grid 30 with a conductive layer 37 inserted between the electric element 34 and the grid 30. An insulating layer R is placed between the electric element 34 and the conductive layer 37. The radial currents preferably flow in the conductive layer rather than in the substrate which is rendered resistive by the grid. In the case where the currents, which are induced by the presence of the electric element, are low, the losses by the Joule effect are diminished considerably. The conductive layer may be connected, for example, to ground so as to discharge these currents.

In a particular embodiment of the invention already mentioned, the electric element is an inductive element. The phenomenon of induction generates high radial currents in the layers subjacent and superjacent to the inductive element. In the presence of a conductive layer which covers the whole insulation surface, the induced circumferential radial currents are developed in said conductive layer. Besides the thus generated Joule effect, the operation of the inductive element is affected by the inductive coupling which brings about a diminishing of the effective inductance of the inductive element. In a similar case the conductive layer will thus advantageously form an open circuit for the currents induced by the electric element in this layer.

FIG. 4 shows a particular example of a conductive layer 47 which forms an open circuit for the induced currents. Said layer is represented with an inductive element 44 superposed on said conductive layer 47. Here the inductive element is in the form of a metallic spiral track which has an external outline and an internal outline marking off among themselves the boundary of a surface called radiation surface. In this example, the surface of the conductive layer 47 is substantially identical with the radiation surface of the inductive element 44. This conductive layer 47 is realized in low-resistive material or low conductive material and placed perpendicularly to the vectors of the magnetic field developed by the inductive element 44. The conductive layer may comprise, as represented, an alternation of bands 48 and slots 49. The bands 48, which constitute conductive segments, may, for example, be realized in a metallic or polysilicon alloy. As the conductive layer is arranged perpendicularly to the magnetic field vectors developed by the inductive element, an induced current I could appear in the plate if this were realized in a single piece. The alternation of slots 49 and bands 48 arranged perpendicularly to this current I forms an open circuit which inhibits the circulation of such induced current. As this current is then almost zero in the conductive layer, the mutual inductance which may appear between said layer and the inductive element is also nearly zero and does not significantly alter the quality factor of the inductive element. The bands are connected on the exterior to a non-closed frame C. A slot F in the frame C prevents the formation of a current loop in the frame.

FIG. 5 is a plan view of two inductive elements included in an integrated circuit in accordance with a variant of the invention. The circuit shown is in the form of a single spiral track. This spiral track includes two inductive elements 54a and 54b hatched differently in the figure. These two inductive elements are symmetrical and overlap. They are both connected between a potential terminal, which may be either a supply terminal VCC of fixed or variable potential, depending on the application for which the circuit is intended, or a terminal of reference potential or ground GND, and a terminal connecting the inductive element 54a or 54b to a sub-circuit and intended to be passed through by a current I1 flowing between said terminals. In these two inductive elements, the current always flows in the same direction, in conformity with the arrows shown in FIG. 5. The mutual inductance between two neighboring and parallel tracks depends on the direction in which the current flows. When the directions in which the currents flow are each other's opposites, the mutual inductance is subtracted from the self-inductance of each coil. When the directions in which the currents flow are identical, the mutual inductance is added to the self-inductance of each track. In the structure proposed here, the parts of neighboring spiral tracks are run through by currents of identical direction: thus the inductances of two inductive elements are augmented and so are their quality factors. In consequence, the performance of the circuit is improved. When the invention is applied, an insulation device in accordance with one of those represented by the various preceding Figures is advantageously superposed on the spiral track which forms the inductive elements 54a and 54b. These two inductive elements thus have high quality factors.

FIG. 6 is a functional diagram of an oscillator VCO realized in the form of an integrated circuit in accordance with the invention. This oscillator VCO is intended to produce a voltage signal Vlo which has a frequency FLO whose value depends on that of a tuning voltage Vtun. This oscillator comprises an inductive element 64 insulated by a device according to the invention, connected to a supply terminal VCC, and an active area ACT comprising a varicap diode VCD intended to be biased by the tuning voltage Vtun. As the varicap diode VCD has a capacitance which varies as a function of the value of its bias voltage, the resonant frequency of the L-C circuit is also variable. The presence of the insulation device of the inductive element prevents the propagation of an electromagnetic radiation to the active area ACT.

FIG. 7 shows in a diagram a radio signal receiving device, for example, a radiotelephone, a television set or a decoder box comprising an input stage AF formed in this example by an antenna system and a filter system, permitting of the reception of a radio signal whose frequency FR, called radio frequency, is selected in a given frequency range and its transformation into an electronic signal Vfr of said radio signal. This receiving device further includes a frequency converter FC comprising a local oscillator VCO and a mixer MIX which is intended to receive the radio signal Vfr and a signal Vlo coming from the local oscillator VCO whose frequency FLO, called oscillation frequency, is tunable, and intended to produce an output signal Vfi which has an intermediate frequency FI which is fixed and equal to the difference between the radio frequency FR and the oscillation frequency FLO.

In this frequency converter FC, the choice of the value of the oscillation frequency FLO made by means of a tuning voltage Vtun lays down the value of the radio frequency FR, as the intermediate frequency FI is rendered fixed, for example, by means of a filter system not shown in the figure, which would be arranged at the output of the mixer MIX. This receiving device finally comprises a signal processing unit PU intended to use the output signal of the mixer MIX.

The invention permits to obtain a large spectral purity for the output signal of the local oscillator VCO, because of the high quality factor of the inductive elements included in said oscillator. This spectral purity permits of a precise selection of the radio frequency and, thanks to the invention, is not obtained at the cost of higher cumbersomeness of the local oscillator VCO.

1. An insulation device intended to avoid the propagation of electromagnetic radiation produced by at least one electric element integrated with a low-resistivity substrate, said insulation device including a plurality of isolation trenches which stretch out in the substrate and are substantially parallel to each other, said trenches containing a resistive material which has a higher resistivity than the resistivity of the substrate, characterized in that it includes a plurality of series of isolation transverses which have a depth that is close to that of said isolation trenches, and which contain a resistive material that has a higher resistivity than the resistivity of the substrate, each series being realized transversely between two adjacent isolation trenches and arranged so that two transverses included in two adjacent series are not each other's extension.

2. An insulation device as claimed in claim 1, characterized in that the electric element is an inductive element which has an outside contour that marks off the boundary of a surface called insulation surface and in that the insulation device has a substantially identical surface to said insulation surface.

3. An insulation device as claimed in one of the claims 1 and 2, characterized in that it includes a conductive layer disposed between the electric element and the substrate, and means for insulating the conductive layer from the electric element.

4. An insulation device as claimed in claim 3, characterized in that the conductive layer forms an open circuit.

5. An insulation device as claimed in claims 3 and 4, characterized in that, since the inductive element has an outside contour and an inside contour marking off the boundary of a surface called radiation surface, the conductive layer has a substantially identical surface to the radiation surface.

6. An integrated circuit comprising at least an electric element integrated with a low-resistivity substrate and is insulated via an insulation device as claimed in one of the claims 1 to 5.

7. An oscillator intended to produce an output signal which has a frequency whose value depends on the value of a tuning voltage, which oscillator includes:
at least an inductive element,
at least a varicap diode intended to be biased by the tuning voltage, and
an insulation device as claimed in claim 1.

8. A radio signal receiving apparatus, comprising:
an input stage which permits of the reception of a radio signal which has a frequency called radio frequency selected from a given frequency range, and its transformation into an electronic signal called radio signal,
a local oscillator having a frequency called oscillation frequency which can be tuned by a tuning voltage, and
a mixer intended to receive the radio signal and a signal coming from the local oscillator and to produce an output signal which has a fixed frequency which is equal to the difference between the radio frequency and the oscillation frequency, and
a signal processing unit intended to use the output signal of the mixer, which apparatus is characterized in that the local oscillator is as claimed in claim 7.
